(19) United States
(12) Patent Application Publication
(10) Pub. No.: US 2023/0191238 A1
(43) Pub. Date: Jun. 22, 2023

(54) TABLE-TOP SOCCER BOARD GAME AND METHOD OF GAMEPLAY

(71) Applicant: WEST AFRICAN XCHANGE, LLC, Sheridan, WY (US)

(72) Inventor: Kahli Abdu, Bowie, MD (US)

(21) Appl. No.: 17/554,122

(22) Filed: Dec. 17, 2021

(51) Int. Cl. A63F 7/06; B67B 7/16

(52) U.S. Cl. CPC A63F 7/0616; B67B 7/16

(57) ABSTRACT

The present invention relates generally to games and, more particularly, to a table-top soccer board game using bottle caps and goalie playing pieces that each include a bottle opener. Methods of gameplay are also provided, along with a kit comprising the table-top soccer board game packaged along with instructions that provide the gameplay rules.

### FIELD OF THE INVENTION

The present invention relates generally to games and, more particularly, to a table-top soccer board game using bottle caps and goalie playing pieces that each include a bottle opener.

### BACKGROUND OF THE INVENTION

Many table-top games are known in the art, with each game requiring different skill sets in order to play them effectively. There remains room in the art for additional games that provide an incentive for the players to utilize various combinations of skills in order to be successful at the game. The present invention is directed toward a novel table-top soccer game using bottle caps and goalie playing pieces that each include a bottle opener.

### SUMMARY OF THE INVENTION

The present disclosure provides compositions and methods as described by way of example as set forth below.

A table-top soccer board game for two players is provided, comprising:
a) five game pieces for each player, comprising:
   i) one goalkeeper game piece comprising a bottle opener;
   ii) four player game pieces, wherein each player game piece comprises a bottle cap; and
   iii) a ball game piece comprising a round and flat shape;
b) a game board adapted to be disposed upon a supporting surface for receiving the game pieces, wherein the game board comprises:
   i) a playing field bisected by a line into two player home fields, wherein the line is bisected by a center circle area;
   ii) a goal area disposed within each of the two player home fields, wherein each of the goal areas are opposite the center circle area and comprise a goal box area and a recess for receiving the ball game piece; and
   iii) a border wall surrounding the playing field and configured to prevent the game pieces from sliding off of the game board; and
c) rule means for moving the game pieces such that the players take turns attempting to score a goal by moving the ball game piece past the other player's goalkeeper in the other player's goal box area and into the recess in the other player's goal area, wherein moving the ball game piece comprises flicking or hitting one of the player game pieces into the ball game piece, and wherein a player wins by scoring a predetermined number of goals.

In some embodiments of the table-top soccer board game of the present invention, the rule means further comprise the following rules:
i) during gameplay, each player may position their game pieces strategically across the playing field;
ii) player game pieces may only be moved or repositioned during a turn or before a free kick or throw-in;
iii) during each turn, each player game piece may pass the ball game piece to another player game piece or shoot to score a goal;
ii) when the ball game piece is in a player's goal box, that player's goalkeeper game piece may clear the ball game piece, wherein a goalkeeper is allowed to score if the ball game piece goes into the recess in the other player's goal area;
iii) if a player hits the ball game piece out of the playing field the ball game piece is considered out of bounds and the other player may throw the ball game piece back into play and take a shot;
iv) if a player commits a foul outside of their goal area, the other player may play a free kick, wherein the ball game piece is placed at the location where the foul occurred and one of the other player's player game pieces is used to attempt a goal, wherein the player who committed the foul may organize their player game pieces and goalkeeper game piece to defend against the free kick, and wherein a foul comprises one or more of the following:
   aa) a hitting foul occurs when a player hits one of the other player's player game pieces or goalkeeper game piece without touching the ball game piece; and
   bb) a dragging foul occurs when a player moves a player game piece without flicking or hitting it;
v) if a player commits a foul inside their goal area, the other player is awarded a penalty shot wherein the other player may place the ball game piece anywhere within the center circle area and one of the other player's player game pieces is used to attempt a goal, wherein the player who committed the foul may only position their goalkeeper game piece to defend against the penalty shot;
vi) players may use the border wall to make trick shots, wherein a player may move any of their own player pieces out of the way of the trick shot and replace those player pieces after the trick shot is complete;
vii) players may use their turn to move their player game pieces into a different configuration without hitting the ball game piece, comprising flicking or hitting one of the player's player game pieces into another one of the player's player game pieces; and
viii) players may use one of their fingers to guide their shots in any direction.

In another embodiment of the table-top soccer board game of the present invention, the rule means further comprise the following rule: whoever scores ten goals first wins. In another embodiment, the game board also comprises a ball retrieval hole disposed in the border wall and configured to enable passage of the ball game piece therethrough.

In another embodiment, a table-top soccer board game kit is provided, comprising a table-top soccer board game as described herein packaged with instructions, wherein the instructions comprise the rule means.

A method of playing a five-a-side table-top soccer game for two players is also provided, comprising:
a) providing a table-top soccer board game for two players, comprising:
   i) five game pieces for each player, comprising:
      A) one goalkeeper game piece comprising a bottle opener;
      B) four player game pieces, wherein each player game piece comprises a bottle cap; and
      C) a ball game piece comprising a round and flat shape;
   ii) a game board adapted to be disposed upon a supporting surface for receiving the game pieces, wherein the game board comprises:
      A) a playing field bisected by a line into two player home fields, wherein the line is bisected by a center circle area;
      B) a goal area disposed within each of the two player home fields, wherein each of the goal areas are opposite the center circle area and comprise a goal box area and a recess for receiving the ball game piece; and
      C) a border wall surrounding the playing field and configured to prevent the game pieces from sliding off of the game board;
   iii) rule means for moving the game pieces such that the players take turns attempting to score a goal by moving the ball game piece past the other player's goalkeeper in the other player's goal box area and into the recess in the other player's goal area, wherein moving the ball game piece comprises flicking or hitting one of the player game pieces into the ball game piece, and wherein a player wins by scoring a predetermined number of goals;
b) positioning the game pieces for each player at a starting position; and
c) alternating turns between each player until one player wins by scoring a predetermined number of goals.

In some embodiments of the method of playing a five-a-side table-top soccer game of the present invention, the rule means further comprise the following rules:
A) during gameplay, each player may position their game pieces strategically across the playing field;
B) player game pieces may only be moved or repositioned during a turn or before a free kick or throw-in;
C) during each turn, each player game piece may pass the ball game piece to another player game piece or shoot to score a goal;
D) when the ball game piece is in a player's goal box, that player's goalkeeper game piece may clear the ball game piece, wherein a goalkeeper is allowed to score if the ball game piece goes into the recess in the other player's goal area;
E) if a player hits the ball game piece out of the playing field the ball game piece is considered out of bounds and the other player may throw the ball game piece back into play and take a shot;
F) if a player commits a foul outside of their goal area, the other player may play a free kick, wherein the ball game piece is placed at the location where the foul occurred and one of the other player's player game pieces is used to attempt a goal, wherein the player who committed the foul may organize their player game pieces and goalkeeper game piece to defend against the free kick, and wherein a foul comprises one or more of the following:
   AA) a hitting foul occurs when a player hits one of the other player's player game pieces or goalkeeper game piece without touching the ball game piece; and
   BB) a dragging foul occurs when a player moves a player game piece without flicking or hitting it;
G) if a player commits a foul inside their goal area, the other player is awarded a penalty shot wherein the other player may place the ball game piece anywhere within the center circle area and one of the other player's player game pieces is used to attempt a goal, wherein the player who committed the foul may only position their goalkeeper game piece to defend against the penalty shot;
H) players may use the border wall to make trick shots, wherein a player may move any of their own player pieces out of the way of the trick shot and replace those player pieces after the trick shot is complete;
I) players may use their turn to move their player game pieces into a different configuration without hitting the ball game piece, comprising flicking or hitting one of the player's player game pieces into another one of the player's player game pieces; and
J) players may use one of their fingers to guide their shots in any direction.

In another embodiment of the method of playing a five-a-side table-top soccer game of the present invention, the rule means further comprise the following rule: whoever scores ten goals first wins.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 illustrates a perspective view of a game board and game pieces in accordance with one or more embodiments of the invention;

FIG. 2 illustrates a top view of a game board and game pieces in accordance with one or more embodiments of the invention; and

FIG. 3 illustrates a perspective view of the back of the goalkeeper game piece in accordance with one or more embodiments of the invention.

### DETAILED DESCRIPTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

### Table-Top Soccer Board Game and Method of Gameplay

A table-top soccer board game for two players is provided, comprising:
a) five game pieces for each player, comprising:
   i) one goalkeeper game piece comprising a bottle opener;
   ii) four player game pieces, wherein each player game piece comprises a bottle cap; and
   iii) a ball game piece comprising a round and flat shape;
b) a game board adapted to be disposed upon a supporting surface for receiving the game pieces, wherein the game board comprises:
   i) a playing field bisected by a line into two player home fields, wherein the line is bisected by a center circle area;
   ii) a goal area disposed within each of the two player home fields, wherein each of the goal areas are opposite the center circle area and comprise a goal box area and a recess for receiving the ball game piece; and
   iii) a border wall surrounding the playing field and configured to prevent the game pieces from sliding off of the game board; and
c) rule means for moving the game pieces such that the players take turns attempting to score a goal by moving the ball game piece past the other player's goalkeeper in the other player's goal box area and into the recess in the other player's goal area, wherein moving the ball game piece comprises flicking or hitting one of the player game pieces into the ball game piece, and wherein a player wins by scoring a predetermined number of goals.

In some embodiments of the table-top soccer board game of the present invention, the rule means further comprise the following rules:
i) during gameplay, each player may position their game pieces strategically across the playing field;
ii) player game pieces may only be moved or repositioned during a turn or before a free kick or throw-in;
iii) during each turn, each player game piece may pass the ball game piece to another player game piece or shoot to score a goal;
ii) when the ball game piece is in a player's goal box, that player's goalkeeper game piece may clear the ball game piece, wherein a goalkeeper is allowed to score if the ball game piece goes into the recess in the other player's goal area;
iii) if a player hits the ball game piece out of the playing field the ball game piece is considered out of bounds and the other player may throw the ball game piece back into play and take a shot;
iv) if a player commits a foul outside of their goal area, the other player may play a free kick, wherein the ball game piece is placed at the location where the foul occurred and one of the other player's player game pieces is used to attempt a goal, wherein the player who committed the foul may organize their player game pieces and goalkeeper game piece to defend against the free kick, and wherein a foul comprises one or more of the following:
   aa) a hitting foul occurs when a player hits one of the other player's player game pieces or goalkeeper game piece without touching the ball game piece; and
   bb) a dragging foul occurs when a player moves a player game piece without flicking or hitting it;
v) if a player commits a foul inside their goal area, the other player is awarded a penalty shot wherein the other player may place the ball game piece anywhere within the center circle area and one of the other player's player game pieces is used to attempt a goal, wherein the player who committed the foul may only position their goalkeeper game piece to defend against the penalty shot;
vi) players may use the border wall to make trick shots, wherein a player may move any of their own player pieces out of the way of the trick shot and replace those player pieces after the trick shot is complete;
vii) players may use their turn to move their player game pieces into a different configuration without hitting the ball game piece, comprising flicking or hitting one of the player's player game pieces into another one of the player's player game pieces; and
viii) players may use one of their fingers to guide their shots in any direction.

In another embodiment of the table-top soccer board game of the present invention, the rule means further comprise the following rule: whoever scores ten goals first wins. In another embodiment, the game board also comprises a ball retrieval hole disposed in the border wall and configured to enable passage of the ball game piece therethrough. In another embodiment, the goalkeeper game piece further comprises a decorative element.

In another embodiment, a table-top soccer board game kit is provided, comprising a table-top soccer board game as described herein packaged with instructions, wherein the instructions comprise the rule means.

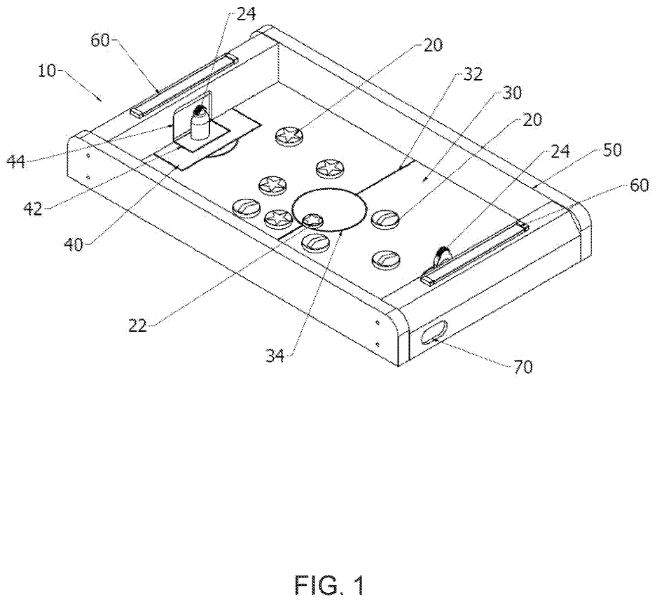

Turning now to FIG. 1, a perspective view is provided of a game board and game pieces in accordance with one or more embodiments of the invention. Game board 10 is adapted to be disposed upon a supporting surface and is configured to receive player game pieces 20, ball game piece 22, and goalkeeper game pieces 24. Game board 10 comprises playing field 30 bisected by line 32, wherein line 32 is bisected by center circle area 34. Playing field 30 also comprises goal areas 40 that are positioned opposite center circle area 34, and which comprise goal box areas 42 and recesses 44 for receiving the ball game piece 22. Game board 10 also comprises border wall 50 surrounding playing field 30 and prevents player game pieces 20, ball game piece 22, and goalkeeper game pieces 24 from sliding off of game board 10. Game board 10 also comprises ball retrieval hole 70 disposed in border wall 50 and configured to enable passage of ball game piece 22 therethrough.

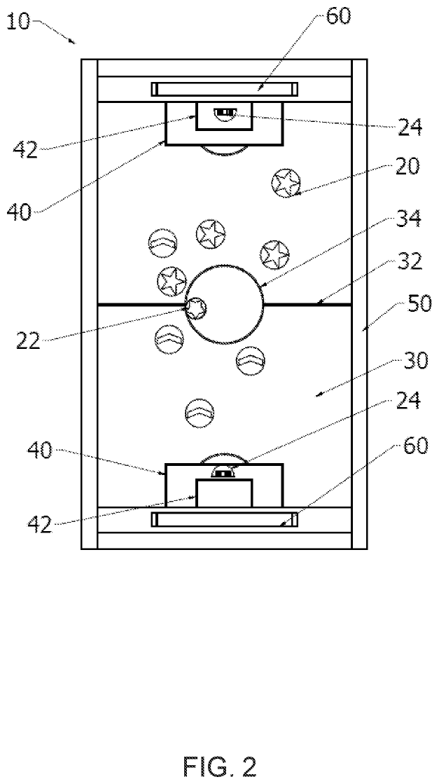

Turning now to FIG. 2, a top view is provided of game board 10, player game pieces 20, ball game piece 22, and goalkeeper game pieces 24. As described above and shown in FIG. 1, game board 10 comprises playing field 30 bisected by line 32, wherein line 32 is bisected by center circle area 34. Goal areas 40 are shown positioned opposite center circle area 34, and comprise goal box areas 42 and recesses 44 for receiving the ball game piece 22. Border wall 50 surrounding playing field 30 is also shown.

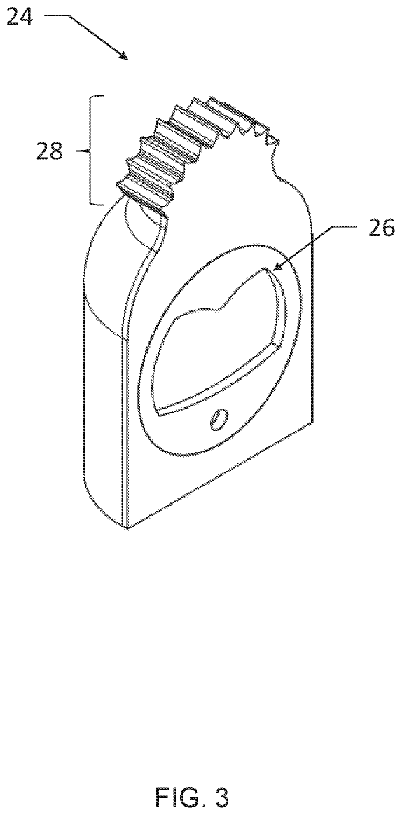

Turning now to FIG. 3, a perspective view is shown of the back of goalkeeper game piece 24 in accordance with one or more embodiments of the invention. Bottle opener 26 is disposed within goalkeeper game piece 24. Goalkeeper game piece 24 also comprises decorative element 28.

A method of playing a five-a-side table-top soccer game for two players is also provided, comprising:
a) providing a table-top soccer board game for two players, comprising:
   i) five game pieces for each player, comprising:
      A) one goalkeeper game piece comprising a bottle opener;
      B) four player game pieces, wherein each player game piece comprises a bottle cap; and
      C) a ball game piece comprising a round and flat shape;
   ii) a game board adapted to be disposed upon a supporting surface for receiving the game pieces, wherein the game board comprises:
      A) a playing field bisected by a line into two player home fields, wherein the line is bisected by a center circle area;
      B) a goal area disposed within each of the two player home fields, wherein each of the goal areas are opposite the center circle area and comprise a goal box area and a recess for receiving the ball game piece; and
      C) a border wall surrounding the playing field and configured to prevent the game pieces from sliding off of the game board;
   iii) rule means for moving the game pieces such that the players take turns attempting to score a goal by moving the ball game piece past the other player's goalkeeper in the other player's goal box area and into the recess in the other player's goal area, wherein moving the ball game piece comprises flicking or hitting one of the player game pieces into the ball game piece, and wherein a player wins by scoring a predetermined number of goals;
b) positioning the game pieces for each player at a starting position; and
c) alternating turns between each player until one player wins by scoring a predetermined number of goals.

In some embodiments of the method of playing a five-a-side table-top soccer game of the present invention, the rule means further comprise the following rules:
A) during gameplay, each player may position their game pieces strategically across the playing field;
B) player game pieces may only be moved or repositioned during a turn or before a free kick or throw-in;
C) during each turn, each player game piece may pass the ball game piece to another player game piece or shoot to score a goal;
D) when the ball game piece is in a player's goal box, that player's goalkeeper game piece may clear the ball game piece, wherein a goalkeeper is allowed to score if the ball game piece goes into the recess in the other player's goal area;
E) if a player hits the ball game piece out of the playing field the ball game piece is considered out of bounds and the other player may throw the ball game piece back into play and take a shot;
F) if a player commits a foul outside of their goal area, the other player may play a free kick, wherein the ball game piece is placed at the location where the foul occurred and one of the other player's player game pieces is used to attempt a goal, wherein the player who committed the foul may organize their player game pieces and goalkeeper game piece to defend against the free kick, and wherein a foul comprises one or more of the following:
   AA) a hitting foul occurs when a player hits one of the other player's player game pieces or goalkeeper game piece without touching the ball game piece; and
   BB) a dragging foul occurs when a player moves a player game piece without flicking or hitting it;
G) if a player commits a foul inside their goal area, the other player is awarded a penalty shot wherein the other player may place the ball game piece anywhere within the center circle area and one of the other player's player game pieces is used to attempt a goal, wherein the player who committed the foul may only position their goalkeeper game piece to defend against the penalty shot;
H) players may use the border wall to make trick shots, wherein a player may move any of their own player pieces out of the way of the trick shot and replace those player pieces after the trick shot is complete;
I) players may use their turn to move their player game pieces into a different configuration without hitting the ball game piece, comprising flicking or hitting one of the player's player game pieces into another one of the player's player game pieces; and
J) players may use one of their fingers to guide their shots in any direction.

In another embodiment of the method of playing a five-a-side table-top soccer game of the present invention, the rule means further comprise the following rule: whoever scores ten goals first wins.

### General Definitions

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art. Although the foregoing subject matter has been described in some detail by way of illustration and example for purposes of clarity of understanding, it will be understood by those skilled in the art that certain changes and modifications can be practiced within the scope of the appended claims.

1. A table-top soccer board game for two players, comprising:
a) five game pieces for each player, comprising:
i) one goalkeeper game piece comprising a bottle opener;
ii) four player game pieces, wherein each player game piece comprises a bottle cap; and
iii) a ball game piece comprising a round and flat shape;
b) a game board adapted to be disposed upon a supporting surface for receiving the game pieces, wherein the game board comprises:
i) a playing field bisected by a line into two player home fields, wherein the line is bisected by a center circle area;
ii) a goal area disposed within each of the two player home fields, wherein each of the goal areas are opposite the center circle area and comprise a goal box area and a recess for receiving the ball game piece; and
iii) a border wall surrounding the playing field and configured to prevent the game pieces from sliding off of the game board; and
c) rule means for moving the game pieces such that the players take turns attempting to score a goal by moving the ball game piece past the other player's goalkeeper in the other player's goal box area and into the recess in the other player's goal area, wherein moving the ball game piece comprises flicking or hitting one of the player game pieces into the ball game piece, and wherein a player wins by scoring a predetermined number of goals.

2. The table-top soccer board game of claim 1, wherein the rule means further comprise the following rules:
i) during gameplay, each player may position their game pieces strategically across the playing field;
ii) player game pieces may only be moved or repositioned during a turn or before a free kick or throw-in;
iii) during each turn, each player game piece may pass the ball game piece to another player game piece or shoot to score a goal;
ii) when the ball game piece is in a player's goal box, that player's goalkeeper game piece may clear the ball game piece, wherein a goalkeeper is allowed to score if the ball game piece goes into the recess in the other player's goal area;
iii) if a player hits the ball game piece out of the playing field the ball game piece is considered out of bounds and the other player may throw the ball game piece back into play and take a shot;
iv) if a player commits a foul outside of their goal area, the other player may play a free kick, wherein the ball game piece is placed at the location where the foul occurred and one of the other player's player game pieces is used to attempt a goal, wherein the player who committed the foul may organize their player game pieces and goalkeeper game piece to defend against the free kick, and wherein a foul comprises one or more of the following:
aa) a hitting foul occurs when a player hits one of the other player's player game pieces or goalkeeper game piece without touching the ball game piece; and
bb) a dragging foul occurs when a player moves a player game piece without flicking or hitting it;
v) if a player commits a foul inside their goal area, the other player is awarded a penalty shot wherein the other player may place the ball game piece anywhere within the center circle area and one of the other player's player game pieces is used to attempt a goal, wherein the player who committed the foul may only position their goalkeeper game piece to defend against the penalty shot;
vi) players may use the border wall to make trick shots, wherein a player may move any of their own player pieces out of the way of the trick shot and replace those player pieces after the trick shot is complete;
vii) players may use their turn to move their player game pieces into a different configuration without hitting the ball game piece, comprising flicking or hitting one of the player's player game pieces into another one of the player's player game pieces; and
viii) players may use one of their fingers to guide their shots in any direction.

3. The table-top soccer board game of claim 2, wherein the goalkeeper game piece further comprises a decorative element.

4. The table-top soccer board game of claim 3, wherein the rule means further comprise the following rule: whoever scores ten goals first wins.

5. The table-top soccer board game of claim 4, wherein the game board also comprises a ball retrieval hole disposed in the border wall and configured to enable passage of the ball game piece therethrough.

6. A table-top soccer board game kit, comprising the table-top soccer board game of claim 1 packaged with instructions, wherein the instructions comprise the rule means.

7. A method of playing a five-a-side table-top soccer game for two players, comprising:
a) providing a table-top soccer board game for two players, comprising:
i) five game pieces for each player, comprising:
A) one goalkeeper game piece comprising a bottle opener;
B) four player game pieces, wherein each player game piece comprises a bottle cap; and
C) a ball game piece comprising a round and flat shape;
ii) a game board adapted to be disposed upon a supporting surface for receiving the game pieces, wherein the game board comprises:
A) a playing field bisected by a line into two player home fields, wherein the line is bisected by a center circle area;
B) a goal area disposed within each of the two player home fields, wherein each of the goal areas are opposite the center circle area and comprise a goal box area and a recess for receiving the ball game piece; and
C) a border wall surrounding the playing field and configured to prevent the game pieces from sliding off of the game board;
iii) rule means for moving the game pieces such that the players take turns attempting to score a goal by moving the ball game piece past the other player's goalkeeper in the other player's goal box area and into the recess in the other player's goal area, wherein moving the ball game piece comprises flicking or hitting one of the player game pieces into the ball game piece, and wherein a player wins by scoring a predetermined number of goals;
b) positioning the game pieces for each player at a starting position; and
c) alternating turns between each player until one player wins by scoring a predetermined number of goals.

8. The method of playing a five-a-side table-top soccer game of claim 7, wherein the rule means further comprise the following rules:
A) during gameplay, each player may position their game pieces strategically across the playing field;
B) player game pieces may only be moved or repositioned during a turn or before a free kick or throw-in;
C) during each turn, each player game piece may pass the ball game piece to another player game piece or shoot to score a goal;
D) when the ball game piece is in a player's goal box, that player's goalkeeper game piece may clear the ball game piece, wherein a goalkeeper is allowed to score if the ball game piece goes into the recess in the other player's goal area;
E) if a player hits the ball game piece out of the playing field the ball game piece is considered out of bounds and the other player may throw the ball game piece back into play and take a shot;
F) if a player commits a foul outside of their goal area, the other player may play a free kick, wherein the ball game piece is placed at the location where the foul occurred and one of the other player's player game pieces is used to attempt a goal, wherein the player who committed the foul may organize their player game pieces and goalkeeper game piece to defend against the free kick, and wherein a foul comprises one or more of the following:
AA) a hitting foul occurs when a player hits one of the other player's player game pieces or goalkeeper game piece without touching the ball game piece; and
BB) a dragging foul occurs when a player moves a player game piece without flicking or hitting it;
G) if a player commits a foul inside their goal area, the other player is awarded a penalty shot wherein the other player may place the ball game piece anywhere within the center circle area and one of the other player's player game pieces is used to attempt a goal, wherein the player who committed the foul may only position their goalkeeper game piece to defend against the penalty shot;
H) players may use the border wall to make trick shots, wherein a player may move any of their own player pieces out of the way of the trick shot and replace those player pieces after the trick shot is complete;
I) players may use their turn to move their player game pieces into a different configuration without hitting the ball game piece, comprising flicking or hitting one of the player's player game pieces into another one of the player's player game pieces; and
J) players may use one of their fingers to guide their shots in any direction.

8. The method of playing a five-a-side table-top soccer game of claim 6, wherein the rule means further comprise the following rule: whoever scores ten goals first wins.
